(19) United States
(12) Patent Application Publication
(10) Pub. No.: US 2002/0016098 A1
(43) Pub. Date: Feb. 7, 2002

(54) Electrical wiring device with multiple types of wire terminations

(76) Inventors: Patrick Poh, East Northport, NY (US); Juan M. Lopez, Jamaica, NY (US)

Correspondence Address: Greenberg Traurig, LLP, 885 Third Avenue, New York, NY, 10022, US

(21) Appl. No.: 09/952,098

(22) Filed: Sep. 15, 2001

Related U.S. Application Data
(63) Continuation of application No. 09/426,458, filed on Oct. 25, 1999, now abandoned.

(51) Int. Cl. H01R 4/66

(52) U.S. Cl. 439/107

(57) ABSTRACT

A wiring device is provided with three different ways in which the bared end of an electrical conductor can be coupled to the contacts inside the body of a wiring device. A clamping plate is placed upon the threaded body of a terminal screw. In a first arrangement the bared end is formed about the terminal screw and trapped between the head of the terminal screw and a first surface of the clamping plate which forces the conductor into firm contact with the first surface of the clamping plate. In another arrangement the straight bared end of the conductor is trapped between a second surface of the clamping plate and a contact plate. The movement of the conductor and clamping plate is controlled by the terminal screw. Apertures are placed in the bottom of the device housing adjacement the contacts in the housing. A contact arm, formed as a one-way clutch grips the straight bared end of a conductor to make contact with the contacts of the device but prevents withdrawal of the conductor.

### BACKGROUND OF THE INVENTION

1. Field of the Invention

The instant invention is directed to the field of wiring devices and more particularly to wiring devices having multiple means to connect electrical conductors to such wiring devices.

2. Description of the Prior Art

Prior art devices have terminal screws which permit the bared end of an electrical conductor to be placed under the head of such terminal screw or push-in sections which allow the bared end of an electrical conductor to be inserted therein or a combination of a terminal screw and clamping plate which traps the bared end of an electrical conductor between a clamping plate and a contact pad of a wiring device. Although some of these approaches can be combined in one wiring device none are available which offer all three conductor to wiring device techniques.

### SUMMARY OF THE INVENTION

The instant invention provides a wiring device which provides all three of the above-described electrical conductor to wiring device wiring techniques. The wiring device has a number of contact pads, one for each contact of the wiring device. The surface of the contact pad is scored to permit it to better grip the bared end of an electrical conductor. A threaded aperture in the contact pad threadingly engages a threaded terminal screw. The bared end of an electrical conductor can be bent into a u-shape and placed about the threaded portion of the terminal screw and is engaged by the backside of the terminal screw head and front surface of a clamping plate. The u-shaped conductor can be closed into a circular shape before the terminal screw is tightened. A clamping plate is positioned on the terminal screw and is moved by the terminal screw towards the contact pad to trap the straight, bared end of an electrical conductor between the clamping plate and the contact pad. An aperture is provided in the bottom of the wiring device housing at each contact of the wiring device and partially blocked by the free end of a spring member formed as a one-way clutch. The bared end of an electrical conductor can be inserted in an aperture to displace the free end of the spring member. Any attempted withdrawal of the conductor forces the end of the spring member to bite into the conductor and prevent its withdrawal. It is an object of this invention to provide an improved wiring device.

It is an object of this invention to provide a novel wiring device which permits electrical conductors to be coupled thereto using three coupling means.

Other objects and features of the invention will be pointed out in the following description and claims and illustrated in the accompanying drawings, which disclose, by way of example, the principles of the invention, and the best mode which is presently contemplated for carrying them out.

### BRIEF DESCRIPTION OF THE DRAWING

In the drawings in which similar elements are given similar reference characters:

FIG. 1 is a front elevational view of a wiring device according to the prior art.

FIG. 2 is an exploded perspective view of the contact pads and terminal screws of the device of FIG. 1.

FIG. 3 is a front elevational view of the front surface of a clamping plate showing the bared end of an electrical conductor wrapped about a portion of a terminal screw, shown in section.

FIG. 4 is an exploded view of the contact pad of FIG. 2 with a clamping plate positioned between a terminal screw head and a contact pad.

FIG. 5 is a side elevational view of the components of FIG. 4 assembled.

FIG. 6 is a bottom plan view of the wiring device of FIG. 1.

FIG. 7 is a fragmentary, partly in section, portion of the wiring device of FIG. 1.

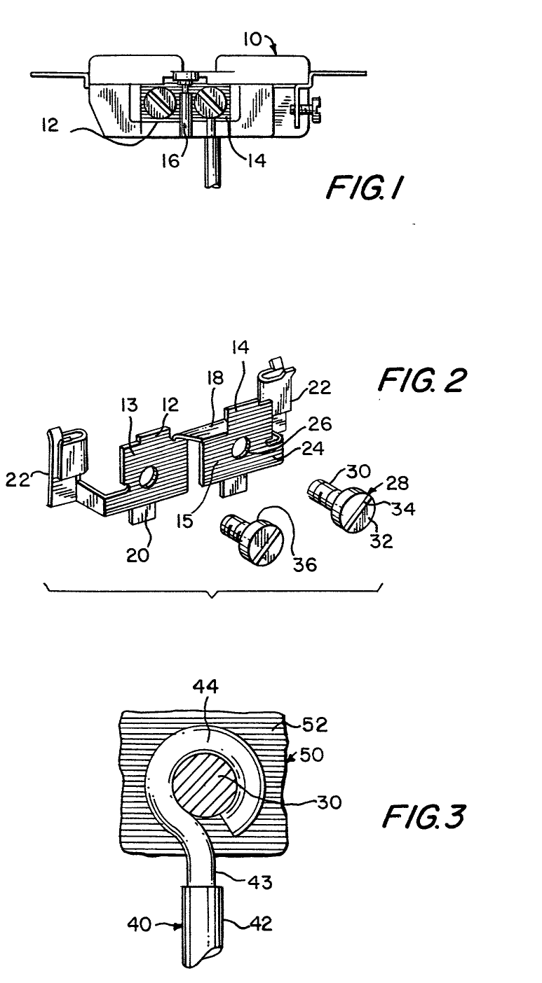

### DESCRIPTION OF THE PREFERRED EMBODIMENT

Turning to FIGS. and 2 there is shown a wiring device 10 which may be a receptacle or switch or the like. Two contact pads 12 and 14 appear in a recess within the side of the body of wiring device 10. A barrier 16 of insulating material separates the contact pads 12 and 14 and is employed when the contact pads 12 and 14 are separately wired. A bridge 18 of metal joins the contact pads 12 and 14 if the circuits are wired in common and may be removed when the circuits are to be separately wired. Tabs 20 and side wings 22 are employed to anchor the contact pads 12 and 14 in place in the body of wiring device 10. Each of front faces 13 and 15, respectively, of the contact pads 12 and 14 are serrated as at 24 to better grip a conductor placed thereon. Further, each of the contact pads 12, 14 has a threaded aperture 26 therein to threadably engage the threaded portion 30 of a terminal screw 28. The terminal screw 28 has a head 32 which includes a slot 34 to receive a screw driver to tighten or loosen the terminal screw 28. The underside 36 of head 32 is made to bear on a conductor or a clamping plate as will be described below.

In a first way to attach a conductor 40 to a wiring device, the insulation 42 is stripped from one end of conductor 40 and the bared conductor 43 is generally bent into a u-shaped loop 44. Once it is placed about the threaded portion 30 of terminal screw 28 the u-shaped loop 44 may be further bent about threaded portion 30 to form a near full circle as show in FIG. 3. The loop 44 is positioned between the serrated front face 52 of clamping plate 50 and the underside 36 of the terminal screw head 32. The terminal screw 28 is now advanced until the clamping plate 50 is in contact with the contact pad 12 and the loop 44 is trapped between the serrated front surface 52 of clamping plate 50 and the underside 36 of the terminal screw head 32.

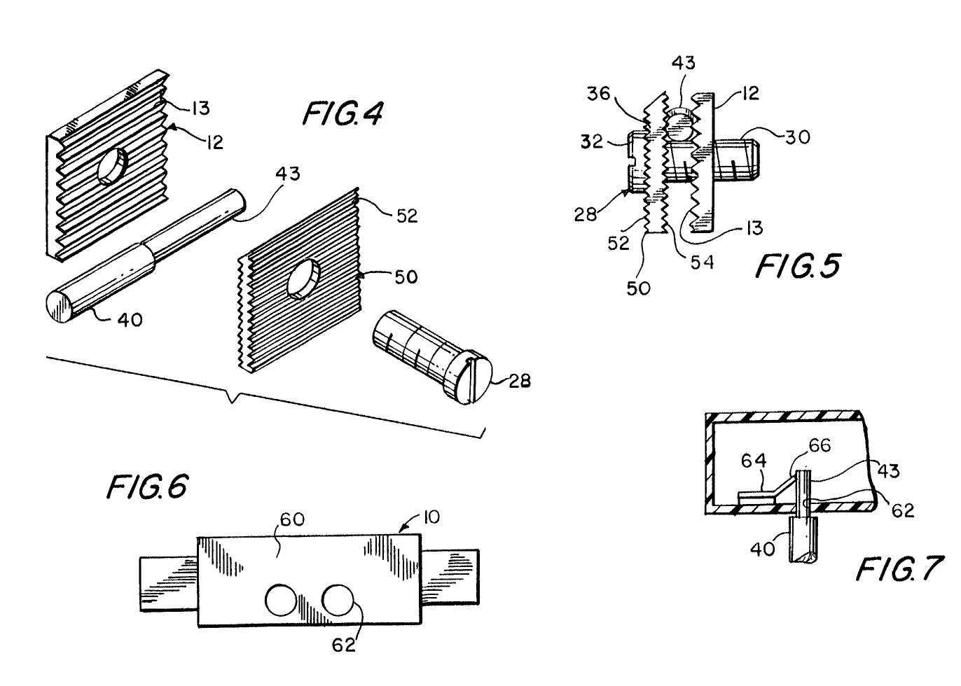

A second way in which the bared end 43 of an electrical conductor 40 can be attached to wiring device 10 is by trapping the bared end 43 of the electrical conductor 40 between the serrated rear face 54 of clamping plate 50 and the serrated front face 13 of the contact pad 12 as shown in FIGS. 4 AND 5. The bared end 43 of the conductor 40 is placed on the serrated front face 13 of contact pad 12 and the terminal screw 28 is advanced. The underside 36 of the head 32 bears on the front face 52 of clamping plate 50 and moves the clamping plate 50 towards the contact pad 12. Upon sufficient tightening of the terminal screw 28, the bared end 43 of the electrical conductor 40 is held between the serrated rear face 54 of clamp plate 50 and the serrated front face 13 of the contact pad 12. The operation of a clamping plate with contact pad 14 is the same as described with respect to contact pad 12.

The bottom surface 60 of the wiring device 10 contains apertures 62 as shown in FIGS. 6 and 7, adjacent to the contacts in the wiring device 10. Adjacent to each aperture 62 is a spring metal contact 64 having a free end 66. The spring contact 64 is so shaped and biased that it acts as a one-way clutch. The bared end 43 of electrical conductor 40 when inserted in aperture 62 deflects the spring contact 64 which remains in intimate contact with the bared end 43. Any attempt to remove a conductor 40 causes the free end 66 to bite into bared end 43 and prevent withdrawal of the conductor 40. The intimate contact between the bared end 43 and the free end 66 of spring contact 64 provides the electrical connection between wiring device 10 and conductor 40. The push in method just described provides the third method of connecting the wiring device 10 to an electrical conductor 40.

While there have been shown and described and pointed out the fundamental novel features of the invention as applied to the presently preferred embodiment, it will be understood that various omissions and substitutions and changes of the form and details of the device illustrated and in its operation may be made by those skilled in the art, without departing from the spirit of the invention.

We claim:

1. An electrical wiring device with multiple types of wire terminations comprising:
a) a wiring device body member having a top portion and a bottom portion;
b) at least one contact in said bottom portion of said wiring device;
c) at least once contact pad, one for each of said at least one contact, each of said at least one contact pad mounted in a recess in a side wall of said bottom portion;
d) at least one terminal screw, one for each of said at least one contact pad, each threadably engaging a threaded aperture in said at least one contact pad, said at least one terminal screw each having a head and a threaded body extending therefrom;
e) at least one clamping plate, one for each of said at least one terminal screw, each having a first surface and a second surface, said at least one clamping plate each placed on an associated one of said at least one terminal screw threaded bodies to permit said second surface of each of said at least one clamping plate to be moved towards an associated one of said at least one contact pad to permit the bared end of a conductor to be shaped and placed about the threaded body of at least one terminal screw and held between the head of said at least one terminal screw and the first surface of its associated at least one clamping plate or remain straight and be placed between the second surface of an associated one of said at least one clamping plates and an associated at least one contact pad;
f) at least one aperture in said bottom portion of said body member, each of said at least one apertures adjacent to an associated at least one contact; and
g) at least one spring contact, each of said at least one spring contact mounted adjacent an associated at least one aperture; said at least one spring contact permitting the bared end of a straight conductor to be inserted in an associated at least one aperture and make contact with an associated at least one spring contact but prevents withdrawal of the at least one the conductor from said at least one spring contact and said at least one contact.

2. An electrical wiring device, as defined in claim 1, wherein the first surface of said clamping plate is serrated to better grip a bared end of a conductor of placed between said head of said at least one terminal screw and said first surface of said at least one clamping plate.

3. An electrical wiring device, as defined in claim 1, wherein a surface of said at least one contact pad is serrated to better grip a bared end of a conductor trapped between said second surface of said at least one clamping plate and its associated at least one contact pad.

4. An electrical wiring device, as defined in claim 1, comprising:
a) said first surface of said at least one clamping plate is serrated to better grip a bared end of a conductor placed between said head of said one of said terminal screws and its associated at least one clamping plate; and
b) said surface of said at least one contact pad is serrated to better grip a bared end of a conductor trapped between said surface of said at least one clamping plate and its associated at least one contact pad.
